(19) United States
(12) Patent Application Publication
(10) Pub. No.: US 2015/0267819 A1
(43) Pub. Date: Sep. 24, 2015

(54) Seal Element Having Contoured V-Spring

(71) Applicant: Vetco Gray Inc., Houston, TX (US)

(72) Inventor: Khanh Anh Duong, Houston, TX (US)

(73) Assignee: Vetco Gray Inc., Houston, TX (US)

(21) Appl. No.: 14/218,528

(22) Filed: Mar. 18, 2014

(51) Int. Cl. F16K 3/02

(52) U.S. Cl. CPC F16K 3/0227

(57) ABSTRACT

A gate valve for use in oil field applications having a seal assembly made up of an elastomeric case and a spring in the case having a V-shaped cross section. The spring has legs that depend from one another, and free ends of the legs that are contoured towards one another to define a rounded surface on outer surfaces of the legs. The rounded surface reduces stress contact between the spring and the case, thereby prolonging seal assembly life. The seal assembly can be placed between a stem in the valve and a gland packing. Other seal assembly locations include between a seat ring and counterbore in the valve body.

### BACKGROUND OF THE INVENTION

1. Field of the Invention

The present disclosure relates to hardware for the production of hydrocarbons, and in particular to a seal element for use in valves used in hydrocarbon production.

2. Brief Description of Related Art

Typical gate valves used in connection with oil and gas operations have a valve body with a flow passageway that extends therethrough. The flow passageway intersects a central cavity in which a gate is typically reciprocated. The gate has an opening, and moves between open and closed positions. When in the open position, the opening is aligned with the fluid path so that fluid can flow therethrough. Conversely, when the gate is in the closed position, the gate blocks the flow passageway. Annular valve seats are usually provided in the valve body on opposing sides of the gate, the valve seats circumscribe the passage and seal against the valve to prevent cross flow between the flow passageway and central cavity. Valve gates typically attached to a stem, which controls the position of the gate between the open and closed positions and inserts through an axial bore in the valve body. A gland packing is usually installed in an annular space between the stem and axial bore. Seal elements are often installed with the valve seats and gland packing that seal between the valve body, elements of the gland packing, and valve body.

### SUMMARY OF THE INVENTION

Disclosed herein are examples of a valve assembly. In an example the valve assembly includes a valve body, where the valve body has a flow passageway, a cavity that is intersected by the flow passageway, and an axial bore in communication with the cavity. Also included with the valve assembly is a stem that inserts into the axial bore and a seal assembly disposed in the valve body. In this embodiment the seal assembly is made up of an annular elastomeric casing and an annular spring having a V-shaped cross section disposed in a recess in the casing and that has legs with free ends that are contoured towards one another so that a rounded surface is formed on inner and outer curved surfaces of the spring. The seal assembly can be disposed between the stem and a gland packing that is inserted in the axial bore and circumscribes the stem, and wherein the seal assembly defines a seal on the stem. The valve assembly can further have a plurality of seal assemblies in sealing contact around the stem, and wherein the gland packing has annular members that couple together in the annular space between the stem and the axial bore. Counterbores can be formed in the flow passageway and annular seat rings can be inserted into the counterbores, wherein a seal assembly is disposed in each of the counterbores, and the seat rings have a face that contacts opposing surfaces of a gate that is attached to the stem. Further included in this example are primary seal assemblies in annular spaces between the seat rings and the counterbores, wherein the seal assemblies are secondary seal assemblies, and wherein the primary seal assemblies are between the secondary seal assemblies and the faces. The valve body is optionally connected to a wellhead assembly that is used for producing hydrocarbons from a subterranean formation. In an example, the free ends angle from the legs of the spring at a value of from about 5° to about 25°.

In another example the valve assembly includes a valve body, where the valve body has a flow passageway, a cavity that is intersected by the flow passageway, and an axial bore in communication with the cavity a stem that inserts into the axial bore, a gland packing in the axial bore and that circumscribes the stem, an annular seal assembly that circumscribes and seals around the stem, and that comprises an annular elastomeric casing and an annular spring having a V-shaped cross section disposed in a recess in the casing and that has legs with free ends that are contoured towards one another at an angle from the legs so that a rounded surface is formed on inner and outer curved surfaces of the spring. The seal assembly may be a gland seal assembly and where the valve assembly further includes a valve seat seal assembly that is disposed between a seat ring and a counterbore in the valve body. This example can further include primary seal assemblies in annular spaces between the seat rings and the counterbores, wherein the seal assemblies are secondary seal assemblies, and wherein the primary seal assemblies are between the secondary seal assemblies and the faces. The angle can range from 5° to 25°. Optionally, the valve body couples to a wellhead assembly used for producing hydrocarbons. A lip can be included on the elastomeric case that depends radially inward and over a one of the free ends of the spring.

Another example of a valve assembly disclosed herein includes a valve body having a flow passageway, a cavity that is intersected by the flow passageway, and an axial bore in communication with the cavity. A counterbore is included in the valve body that circumscribes the passage and a seat ring in the counterbore. An annular seal assembly is between the counterbore and seat ring, and that is made up of an annular elastomeric casing and an annular spring having a V-shaped cross section disposed in a recess in the casing and that has legs with free ends that are contoured towards one another at an angle from the legs so that a rounded surface is formed on inner and outer curved surfaces of the spring. The valve assembly can further include a stem that inserts into the axial bore, and a gland packing around the stem, and wherein the seal assembly is a seat ring seal. A gland packing seal can be disposed between the gland packing and the stem and that defines a seal around the stem. The valve body can connect to a wellhead assembly that produces hydrocarbons. Optionally, the free ends depend from the legs at an angle of at least around 5°.

### BRIEF DESCRIPTION OF THE DRAWINGS

The present technology will be better understood on reading the following detailed description of nonlimiting embodiments thereof, and on examining the accompanying drawings, in which:

FIG. 1 is side cross-sectional view of a gate valve assembly having an example of a seat seal assembly in accordance with the present technology.

FIG. 2 is an enlarged side cross-sectional view of a portion of the gate valve assembly corresponding to area 2 in FIG. 1 and in accordance with the present technology.

FIG. 3 is a sectional view of an example of the seat seal assembly of FIG. 1 and in accordance with the present technology.

FIG. 4 is an enlarged side cross-sectional view of a portion of the gate valve assembly corresponding to area 4 in FIG. 1 and in accordance with the present technology.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout. In an embodiment, usage of the term about includes +/−5% of the cited magnitude.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

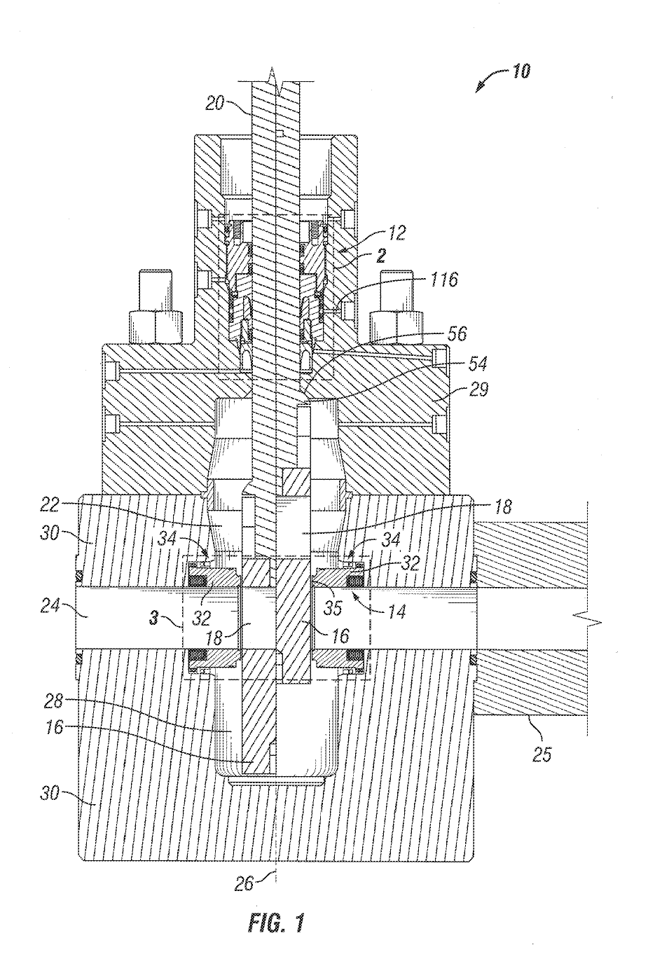

FIG. 1 shows a side cross-sectional view of a gate valve assembly 10 according to an embodiment of the present technology, including examples of a gland packing assembly 12 and valve seat assembly 14. The gate valve assembly 10 includes a gate 16 with an opening 18. The gate 16 is attached to a stem 20, and moves in a central cavity 22 of a valve body 30. The central cavity 22 is perpendicular to and intersects a flow passageway 24 through which fluid can flow. In an example, gate valve assembly 10 is coupled to a wellhead assembly 25 that is used for producing hydrocarbons from a subterranean formation (not shown).

The gate 16 and stem 20 are selectively moved between an open position and a closed position. To illustrate this functionality, in FIG. 1 the gate 16 and stem 20 are shown in a split configuration, with their respective portions that are to the left of a centerline 26 an open position. Similarly, respective portions of the gate 16 and 20 to the right of centerline 26 are illustrated in a closed position. As can be seen, when the gate 16 is in its open position, the opening 18 is aligned with the flow passageway 24 so that fluid in the flow passageway 24 can pass through the opening 18. In its open position, the gate 16 may be received into a recess 28 in the valve body 30. Conversely, when the gate 16 is in its closed position, the gate 16 blocks the flow passageway 24. In the closed position, the opening 18 is moved upward and out of registration with the flow passageway 24; and the gate 16 moves into the flow passageway 24, thereby obstructing the flow of fluid through the flow passageway 24.

Movement of the gate 16 between an open and a closed position may be accomplished by any appropriate means. For example, the embodiment of FIG. 1 shows a rising stem 20, which opens and closes the gate 16 by moving the stem 20 upward and downward relative to the flow passageway 24. Alternate embodiments may include non-rising stems that employ other means, such as threads, to raise and lower the gate 16 without raising and lowering the stem 20 itself. The example of the gate valve assembly 10 shown further includes a bonnet 29 mounted to the valve body 30, and seat rings 32 between the valve body 30 and opposing sides of the gate 16. The seat rings 32 are mounted in counterbores 34 that circumscribe the portions of the passageway 24 adjacent the central cavity 22. Each seat ring 32 is mounted in one of the counterbores 34, and has limited axial movement. The gland packing assembly 12 helps provide a seal between the stem 20 and the bonnet 29. The valve seat assembly 14 seals between each seat ring 32 and the valve body 30. Each seat ring 32 also has a face 35 positioned adjacent to the gate 16 to guide the gate 16.

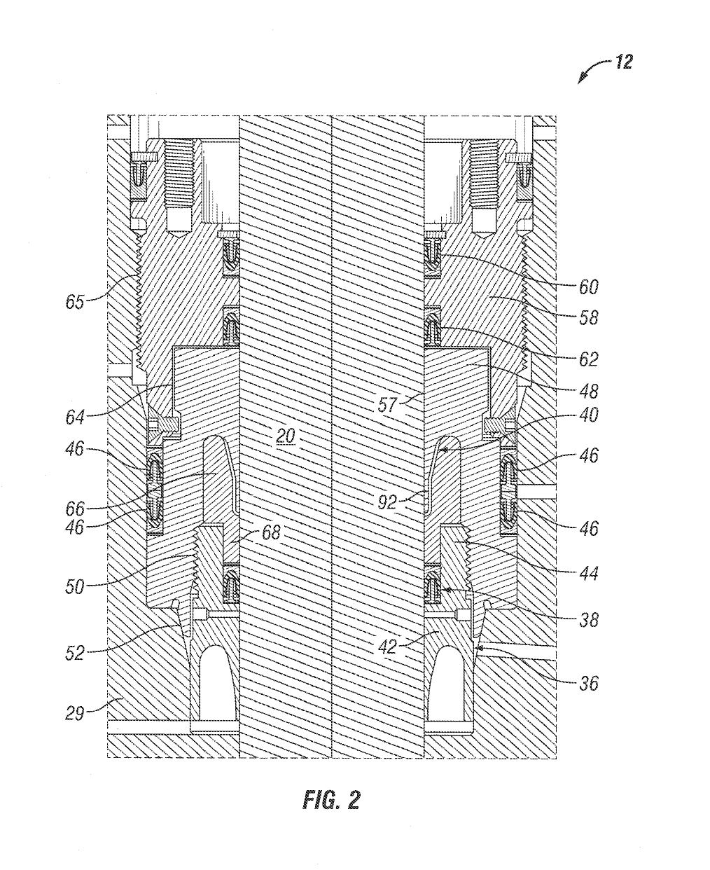

An example of the gland packing assembly 12 from area 2 of FIG. 1 is shown in an enlarged view in FIG. 2. In the illustrated example, the gland packing assembly 12 includes a primary stem seal 36, a secondary stem seal 38, and a tertiary stem seal 40. The primary stem seal 36 includes a sealing portion 42 and an extended portion 44 that extends away from the flow passageway 24 substantially parallel to the stem 20. The primary, secondary, and tertiary stem seals 36, 38, and 40 are carried by a proximal cartridge body 48. As shown in FIG. 2, the extended portion 44 of the primary stem seal 36 may engage the proximal cartridge body 48 at a threaded interface 50. The proximal cartridge body 48 may include a secondary bonnet seal 52 configured to seal against a surface of the bonnet 29.

Referring back to FIG. 1, the stem 20 may include an optional stem protrusion 54 that engages a surface 56 of the bonnet 29 when the gate is in the open position, as shown in FIG. 1. In such embodiments, the engagement between the stem protrusion 54 and the surface 56 of the bonnet 29 creates a backseat seal that is closer to the flow passageway 24 than the gland packing assembly 12. The stem protrusion 54 may be made of metal, so that it is resistant to corrosion, and has structural rigidity. The inclusion of such a backseat seal adds redundancy to the system, thereby further decreasing the risk of leaks between the stem 20 and the bonnet 29.

Referring back to FIG. 2, an annular cartridge body 58 is shown threaded to an inner surface of bonnet 29. Upper and lower seals 60, 62 seal between cartridge body 58 and are provided in recesses in an inner circumference of cartridge body 58. In the embodiment shown, the proximal cartridge body 48 couples to cartridge body 58 along a cartridge interface 64, with the cartridge body 58 partially surrounding a portion of the proximal cartridge body 48. In the illustrated example, the cartridge bodies 48, 58 are held together by axially applied compression loads acting on the gland packing assembly 12. In some embodiments, however, the cartridge bodies 48, 58 may be integral with one another, and form a single cartridge body. In addition, the distal cartridge body 41 may be threadedly engaged with the bonnet 29 at an interface 65.

An annular spacer 66, positioned between the secondary stem seal 38 and the tertiary stem seal 40, and extending into a cavity behind the tertiary stem seal 40. The annular spacer 66 has a lower end 68 that fits into the annular space between the extended portion 44 of the primary stem seal 36 and the stem 20. One purpose of the annular spacer 66 is to restrain axial movement of the secondary stem seal 38 by providing a barrier to movement of the secondary stem seal 38 toward the tertiary stem seal 40. In alternate embodiments, the annular spacer 66 could be replaced with any mechanism capable of helping to maintain relative movement of the secondary stem seal 38 and the tertiary stem seal 40. For example, the annular spacer 66 could be replaced with a snap ring (not shown).

The gland packing assembly 12 is designed to provide a multi-fault system for retaining pressurized fluids below the gland packing assembly 12, and to prevent such fluids from passing between the stem seal gland packing assembly 12 and the stem 20. Each of the primary, secondary, and tertiary stem seals 36, 38, 40 has a different structure, as described in detail below, and each provides a secure seal against the stem 20 of the gate valve assembly 10. Each seal is structurally independent of the other seals, and is capable of sealing the space between the stem seal gland packing assembly 12 and the stem 20 independent of the other seals. Moreover, together these seals provide a redundancy that maintains the integrity of the interface between the gland packing assembly 12 and the stem 20, even if one or two of the seals fail.

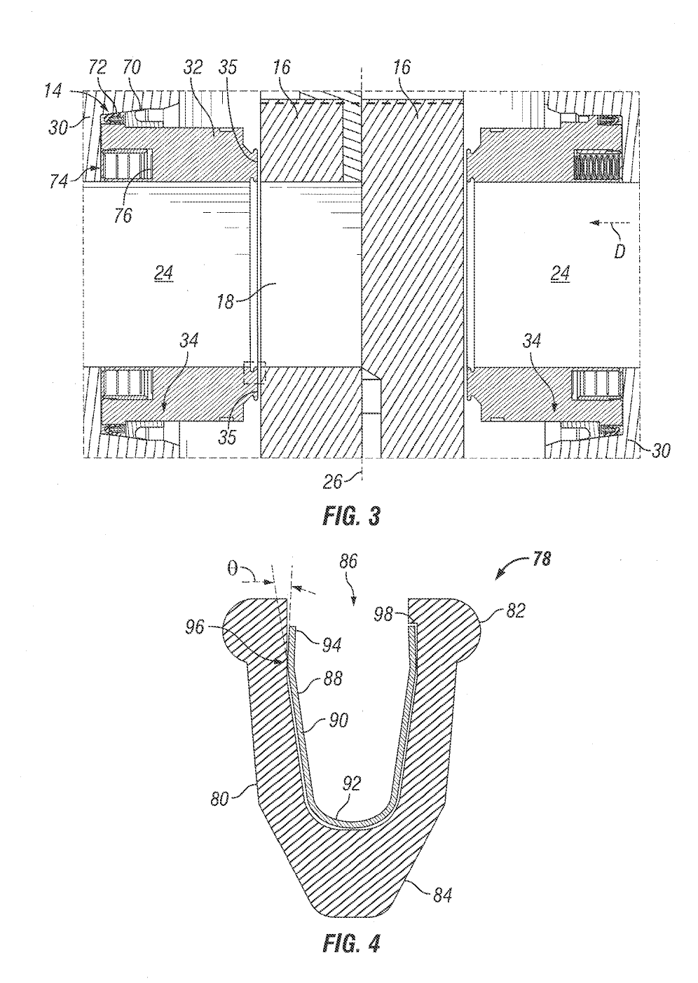

Referring now to FIG. 3, shown is a valve seat assembly 14 according to an exemplary embodiment of the present technology. Shown set between the seat rings 32 and counterbores 34 are a primary seat seal 70 and secondary seat seal 72, wherein the primary seat seal 70 is adjacent the secondary seat seal 72 and on a side proximate the face 35. Optional sand excluders 74 are further illustrated and set in annular recesses 76 on an inner circumference of each seat ring 32. As is known the primary and secondary seat seals 70, 72, define a flow barrier between the seat rings 32 and counterbores 34.

As shown in side sectional view FIG. 4 is a seal assembly 78 that represents an example design for one or more of the secondary stem seal 38, check line seal 46, upper seal 60, lower seal 62, and secondary seat seal 72. Seal assembly 78 includes an annular elastomeric casing 80, with a cross section that is generally V-shaped. As shown in cross section, the casing 80 has legs 82 that project from a base 84 and are spaced away from one another to define an opening 86 between the legs 82. An annular metal spring element 88 with a V-shaped cross section is shown set in the opening 86, that also has legs 90 that project away from a base 92. Free ends 94 of the legs 90 are contoured towards one another and away from the walls of the recess 86 which defines a rounded surface 96 on the inner and outer curved surfaces of the spring element 88.

By contouring the free ends 94 of the legs 90 so that the rounded surface 96 contacts the elastomeric casing 80 lowers stresses between the spring element 88 and casing 80. This in turn reduces damaging forces applied by the spring element 88 against the casing 80 and prolongs the useful life of the casing 80 and thus the seal assembly 78. To retain the spring element 88 in the recess 86, an optional lip 98 is provided on the casing 80 proximate the opening to the recess 86 and on an inner surface and terminal end of one of the legs 82. In an example, the free ends 94 contour at an angle θ from the legs 90 that ranges from about 5° to about 25°.

An advantage to utilizing the embodiments disclosed herein is that a seal made in accordance with the present disclosure seals better after many thermal and/or pressure cycles. Due to the different in thermal expansion of different materials in the seal assembly, the edge end of the spring protrudes into the seal jacket and has a ratcheting effect when the spring and jacket expand at different rate. The result is the jacket will be stretched and flattened after many thermal and pressure cycles until it can no longer seal.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. For example, instead of elastomeric, the subject material can be a polymeric material, a polymeric/elastomeric material, and combinations thereof. This and other similar modifications will readily suggest themselves to those skilled in the art, and are intended to be encompassed within the spirit of the present invention disclosed herein and the scope of the appended claims.

What is claimed is:

1. A valve assembly comprising:
a valve body comprising a flow passageway, a cavity that is intersected by the flow passageway, and an axial bore in communication with the cavity;
a stem that inserts into the axial bore;
a seal assembly disposed in the valve body comprising an annular elastomeric casing and an annular spring having a V-shaped cross section disposed in a recess in the casing and that has legs with free ends that are contoured towards one another so that a rounded surface is formed on inner and outer curved surfaces of the spring.

2. The valve assembly of claim 1, wherein the seal assembly is disposed between the stem and a gland packing that is inserted in the axial bore and circumscribes the stem, and wherein the seal assembly defines a seal on the stem.

3. The valve assembly of claim 1, further comprising a plurality of seal assemblies in sealing contact around the stem, and wherein the gland packing comprises annular members that couple together in the annular space between the stem and the axial bore.

4. The valve assembly of claim 1, further comprising counterbores formed in the flow passageway and annular seat rings inserted into the counterbores, wherein a seal assembly is disposed in each of the counterbores, and the seat rings have a face that contacts opposing surfaces of a gate that is attached to the stem.

5. The valve assembly of claim 4, further comprising primary seal assemblies in annular spaces between the seat rings and the counterbores, wherein the seal assemblies comprise secondary seal assemblies, and wherein the primary seal assemblies are between the secondary seal assemblies and the faces.

6. The valve assembly of claim 1, wherein the valve body is connected to a wellhead assembly that is used for producing hydrocarbons from a subterranean formation.

7. The valve assembly of claim 1, wherein the free ends angle from the legs of the spring at a value of from about 5° to about 25°.

8. A valve assembly comprising:
a valve body comprising a flow passageway, a cavity that is intersected by the flow passageway, and an axial bore in communication with the cavity;
a stem that inserts into the axial bore;
a gland packing in the axial bore and that circumscribes the stem;
an annular seal assembly that circumscribes and seals around the stem, and that comprises an annular elastomeric casing and an annular spring having a V-shaped cross section disposed in a recess in the casing and that has legs with free ends that are contoured towards one another at an angle from the legs so that a rounded surface is formed on inner and outer curved surfaces of the spring.

9. The valve assembly of claim 8, wherein the seal assembly comprises a gland seal assembly and further comprising a valve seat seal assembly that is disposed between a seat ring and a counterbore in the valve body.

10. The valve assembly of claim 9, further comprising primary seal assemblies in annular spaces between the seat rings and the counterbores, wherein the seal assemblies comprise secondary seal assemblies, and wherein the primary seal assemblies are between the secondary seal assemblies and the faces.

11. The valve assembly of claim 8, wherein the angle ranges from 50 to 250.

12. The valve assembly of claim 8, wherein the valve body couples to a wellhead assembly used for producing hydrocarbons.

13. The valve assembly of claim 8, further comprising a lip on the elastomeric case that depends radially inward and over a one of the free ends of the spring.

14. A valve assembly comprising:
a valve body comprising a flow passageway, a cavity that is intersected by the flow passageway, and an axial bore in communication with the cavity;
a counterbore in the valve body that circumscribes the passage and a seat ring in the counterbore;
an annular seal assembly between the counterbore and seat ring, and that comprises an annular elastomeric casing and an annular spring having a V-shaped cross section disposed in a recess in the casing and that has legs with free ends that are contoured towards one another at an angle from the legs so that a rounded surface is formed on inner and outer curved surfaces of the spring.

15. The valve assembly of claim 14, further comprising a stem that inserts into the axial bore, and a gland packing around the stem, and wherein the seal assembly comprises a seat ring seal.

16. The valve assembly of claim 15, further comprising a gland packing seal disposed between the gland packing and the stem and that defines a seal around the stem.

17. The valve assembly of claim 14, wherein the valve body connects to a wellhead assembly that produces hydrocarbons.

18. The valve assembly of claim 14, wherein the free ends depend from the legs at an angle of at least around 5°.
